(19) United States
(12) Patent Application Publication
(10) Pub. No.: US 2025/0070712 A1
(43) Pub. Date: Feb. 27, 2025

(54) Automated Maintenance System for Solar Components

(71) Applicants: Thamer Y. Marghalani, Jeddah (SA); Abdulrahman Alhaddad, Jeddah (SA); Abdullah Alhaddad, Jeddah (SA)

(72) Inventors: Thamer Y. Marghalani, Jeddah (SA); Abdulrahman Alhaddad, Jeddah (SA); Abdullah Alhaddad, Jeddah (SA)

(21) Appl. No.: 18/454,238

(22) Filed: Aug. 23, 2023

(51) Int. Cl. H02S 40/10; B08B 1/16; B08B 1/40; H02S 50/00

(52) U.S. Cl. CPC H02S 40/10; B08B 1/16; B08B 1/40; H02S 50/00

(57) ABSTRACT

An automated maintenance system for solar components is disclosed. The system includes a condensate reservoir, a wiping element, a motor, and a fluid delivery element. The fluid delivery element is configured to transport a fluid from the condensate reservoir to a solar component, and the motor is configured to operate the wiping element via a controller. The system is designed to clean solar components automatically, without the need for manual intervention. The system is efficient, cost-effective, and environmentally friendly.

### TECHNICAL FIELD

The present disclosure relates to automated maintenance, processing, and recovery systems for solar arrays in extreme environments.

### BACKGROUND

Solar components, such as solar panels, require regular cleaning to maintain their efficiency. Dust, dirt, and other debris can accumulate on the surface of the solar components, reducing their ability to absorb sunlight and generate electricity. Manual maintenance of solar components can be time-consuming, labor-intensive, and expensive. Moreover, manual maintenance, or cleaning, can be dangerous, especially when the solar components are installed at a height. To address these challenges, an automated maintenance system for solar components is needed.

The system should be able to maintain solar components automatically, without the need for manual intervention. The system should be efficient, cost-effective, and environmentally friendly. The system includes a condensate reservoir, a cleaning element, a motor, and a liquid delivery element. The system is designed to clean solar components automatically, without the need for manual intervention. The system is efficient, cost-effective, and environmentally friendly

### SUMMARY

In some aspects, the techniques described herein relate to a system for cleaning and maintaining solar components. In some cases, the system for maintaining solar components can include a condensate reservoir that stores a liquid. As used herein, the term “liquid” can refer to, but is not limited to atmospheric water condensation, water from a drainage line of a heat exchanger compressor unit, or any other water source. The reservoir can be connected to a liquid delivery system. In some cases, the liquid delivery element is a system of pipes, pressure vessels, and/or pumps configured to transport the liquid from the condensate reservoir to a solar component. According to embodiments of the present disclosure, the system for cleaning solar components can further include wiping element operable by a motor whereby the motor is configured to operate the wiping element via a controller.

In some aspects, the techniques described herein relate to a system further including a condensate collection element configured to provide nucleation sites for water condensation. The condensate collection element is configured to maximize sun exposure on one side to increase rate of atmospheric condensation formation on the surface of the condensate collection element, in some cases.

In some aspects, the techniques described herein relate to a system wherein the condensate collection element is configured to change from a first position to a second position, wherein the condensate collection element in the first position if configurable to form a condensate channel configured to deliver water to the condensate reservoir. In some cases, the transition from the first position to the second position is a collapsibly folding action, whereby the surface of the condensate collection elements folds, or collapses, in on itself, similar to a hand-fan-like arrangement, and/or a pleated fashion.

In some embodiments, the change from the first position to a second position can be accomplished through the use of a compressive ring operation. In some cases, in the first position the compressive ring is maintained at the base of the condensate collection element, and in the second position the compressive ring is actuated along the condensate collection element, causing the condensate collection element to fold in along itself in a fan-like action, squeezing the condensate collection element, thereby causing the condensate to gravitationally, non-gravitationally, and/or via capillary effect, flow both within and on the surface of, the condensate element, into a collection element and into the reservoir. In some cases, the ring moves along an actuating element.

In some aspects, the techniques described herein relate to a system wherein the condensate collection element has a condensate channel comprising a hydrophobic element and nucleation element. In some cases, the hydrophobic element can be hydrophobic coating can have a contact angle of at least 90 degrees. It is contemplated that in some embodiments the hydrophobic element is a superhydrophobic hierarchical micro/nanostructure such as, but not limited to: sealed layered nanoporous structures, open nanocone structures, organosilane compounds, copper-based compounds, polymeric compounds, or combination thereof. In some cases, the nucleation element has a structure to enable the nucleation of condensate on the condensate collection element. The nucleation element, in some cases, can extend beyond the condensate channel. In some cases, the nucleation element and hydrophobic elements are arranged such that the condensate droplets formed on the nucleation element are gravitationally pulled onto the hydrophobic element, whereby the hydrophobic element and condensate channel are configured to direct condensate to a collection element.

In some aspects, the techniques described herein relate to a stress reduction chamber wherein the top portion includes a wireless capable speaker system. The wireless capable speaker system is configured to deliver one or more audio elements to the interior portion of the stress reduction chamber via a speaker directed into the chamber. In some cases, the wireless capable speaker system is configured to project the audio element towards the wall portion of the stress reduction chamber to bounce the audio element off the wall portion of the stress reduction chamber back into the center of the interior portion of the stress reduction chamber. In some cases, the wireless capable speaker is capable of connecting to a network and can be controlled via the user's hand-held electronic device.

In some aspects, the techniques described herein relate to a system wherein the liquid delivery element includes a pump, configured to couple to with a manifold; wherein the manifold and the pump are operable to deliver the liquid or condensate to a nozzle configured to deliver the liquid to the solar component via a maintenance signal from the controller. The pump can be, but is not limited to: a positive-displacement pump, and velocity pump, and/or an impulse pump. In such cases where the pump is a velocity or impulse pump, the reservoir can also be a pressure vessel exposed to incident solar radiation.

In some aspects, the techniques described herein relate to a system wherein the liquid delivery element further includes a sensor configured to monitor a refraction index of a surface and communicate a positive signal to the controller in reference to a set point of the surface refraction index of the solar component. In some cases, the sensor configured to monitor refraction index comprises as laser beam, a laser screen, a camera, and a central processor, wherein the camera captures the scattering of the laser beam upon the surface of the solar component and the central processor makes a comparison of the angle of incidence of the laser beam to that of the scattered laser beam resulting in a refraction index. In some cases, the central processor further includes a refraction index standard, or set point. In such cases where the sensor measures a refraction index above the set point, the central processor will send a maintenance alert to the controller.

In some aspects, the techniques described herein relate to a system wherein the controller is configured to transmit a maintenance signal to the motor and transmit a pumping signal to the pump. In some cases, the controller will deliver a maintenance signal to the motor, and a pumping signal to the pump, upon receipt of the maintenance alert from the central processor. In some cases, the maintenance signal is transmitted from the controller to the motor via a local network, wherein the controller has a transmitter and the motor has a receiver. In some cases, the pump and controller are configured to communicate via Bluetooth or other radio frequencies. In some cases, the pumping signal is transmitted from the controller to the pump via a local network, wherein the controller has a transmitter and the pump has a receiver.

In some aspects, the techniques described herein relate to a system wherein the manifold also includes a reservoir pressure sensor configured to measure the internal pressure of the reservoir. In some cases, the system also includes a nozzle pressure sensor that is configured to measure the pressure of the nozzle. In some cases, the reservoir and nozzle pressure sensors are configured to each transmit signals to the controller. In such cases, the signals from the reservoir pressure sensor and the nozzle pressure sensor may be transmitted wirelessly through a local network and/or radio frequency, such as Bluetooth. The controller may further include a time delay component. The time delay component is calculated from the pressure signals of the reservoir and nozzle pressure sensor such that a pressure drop between the reservoir pressure sensor and the nozzle pressure sensor can be communicated, via wireless network, radio signal, or otherwise, to the central processing unit, wherein the central processing network can compute a time delay component, wherein the time delay component is transmitted to the controller, such that the transmission of the maintenance signal from the controller to the motor is delayed to a time after the pumping signals is transmitted, thereby communicating the nozzle to spray liquid from the reservoir and manifold before the motor operates the wiping element.

In some aspects, the techniques described herein relate to a system further including a heat exchanger configured to communicate a condensate liquid to the condensate reservoir via a drainage line that extends from the heat exchanger to the condensate reservoir.

In some aspects, the techniques described herein relate to a system further including: a battery, a charge controller, and an inverter; wherein the solar component including a photovoltaic cell is configured to transmit a photovoltaic (PV) current to the charge controller, the charge controller being configured to communicate a charge current to the battery, and the battery being configured to deliver a voltage to the inverter, and the inverter configured to deliver a circuit voltage to the motor, central processing unit, pump, and the controller.

In some aspects, the techniques described herein relate to a system further including an actuator configured to manipulate the condensate collection element interchangeably between the first position and the second position.

In some aspects, the techniques described herein relate to a system further including a filter configured to remove contaminants from the liquid before it is delivered to the solar component. In some cases, the filter may be located in the manifold and be between the condensate collection element and the reservoir. In some cases, the filter includes a vibration chamber configured to communicate with an ultrasonic vibration element. In some cases, the ultrasonic vibration element can vibrate ultrasonically to break up solidified contaminants present in the filter. In some cases, the filter may also include a vacuum element, configured to remove by suction the contaminants that have been ultrasonically vibrated.

In some aspects, the techniques described herein relate to a system further wherein the reservoir is configured to be a pressure vessel; wherein the motor is configured to be pneumatically operably by a pressure of the pressure vessel. In some cases, the central processing unit can calculate the pressure of the reservoir, via the reservoir pressure sensor, and can deliver a pulse-width modulation (PWM) of the pumping signal based on the pressure of the pressure-vessel reservoir.

In some aspects, the techniques described herein relate to a system wherein the controller is configured to modify the PWM of the pumping signal based on the refraction index of the solar component. In such cases, the amount of condensate delivered through the nozzle is increased by the controller via the PWM of the pumping signal to the pump.

In some aspects, the techniques described herein relate to a system further including a timer configured to automatically activate the system at predetermined intervals. The predetermined intervals can be set by user through the use of a user interface configured to communicate through a local network or radio frequency with the controller. The user interface may be a software interface configured to operate on a mobile device, computer, or tablet. In some cases, the user interface may be adapted to communicate with a network enabled web browser.

In some aspects, the techniques described herein relate to a system wherein the wiping element is configured to adjust its angle in order to maximize contact with the solar component. In some cases, the wiping element has an adjustable blade that can be manipulated to adjust the angle that the adjustable blade makes contact with the solar component.

In some aspects, the techniques described herein relate to a system wherein the liquid delivery element is configured to deliver a variety of fluids to the solar component. In some cases, the system may include more than one reservoir, wherein at least one of the reservoirs comprises a low-freezing temperature fluid that comprises a solute and solvent, where the solute decreases the freezing temperature of the solution to beyond or around the solid/liquid/vapor triple point.

In some aspects, the techniques described herein relate to a system further including a heating element configured to heat the fluid before it is delivered to the solar component.

In some aspects, the techniques described herein relate to a method of removing debris from a solar panel, including: Providing a fluid delivery element configured to communicate a fluid between a condensate reservoir and a solar component; a pump and a manifold configured to communicate with each other and deliver fluid to a nozzle configured to spray the fluid upon with the solar component, a motor configured to drive a blade configured to wipe contactingly across a surface of the solar component; and transferring the fluid between the condensate reservoir and the solar component via a fluid delivery element, the fluid delivery element including: pumping the fluid from the condensate reservoir through the manifold to the nozzle; and spraying the fluid onto the solar component.

In some aspects, the techniques described herein relate to a system wherein the fluid delivery element is configured to deliver a variety of liquids to the solar component.

In some aspects, the techniques described herein relate to a method, further including: Providing a condensate collection element including a nucleation site and a condensate channel, the condensate channel configured deliver the fluid into the condensate channel.

In some aspects, the techniques described herein relate to a method wherein the condensate collection element further includes a first position, a second position, the first position configured to maximize a surface are of the condensate collection element, the second position configured to form the condensate channel; positioning the condensate collection element in the first position to collect condensation of water vapor; collecting a fluid condensate at the nucleation site; adjusting the condensate collection element to the second position; forming the condensate channel; and channeling the fluid condensate to the condensate reservoir.

In some aspects, the techniques described herein relate to a method further including: providing an actuator configured to couple with the condensate collection element, and actuate the condensate collection element between the first and the second position; actuating the collection element from the first position to the second position; and actuating the collection element from the second position to the first position.

In some aspects, the techniques described herein relate to a method wherein the fluid delivery element further includes: A sensor configured to monitor and record a refraction index of a solar component and a signal to a controller configured to compare the refraction index to a reference number, and to communicate with the fluid delivery element; Monitoring the refraction index of the solar component; Recording the refraction index; Transmitting the signal to the controller; Comparing the refraction index to a reference number; and controlling the pump and motor on a time delay enabling fluid releasing from the nozzle, and wiping of the blade across the solar component surface.

In some aspects, the techniques described herein relate to a method further including: providing an actuator configured to communicate with the controller and the condensate collection element; and controlling the actuator to adjust the position of the condensate collection element.

In some aspects, the techniques described herein relate to a method further including heating the fluid before it is delivered to the solar component.

In some aspects, the techniques described herein relate to a method further including: Monitoring a temperature of the solar component, and adjusting the heating of the fluid.

In some aspects, the techniques described herein relate to a method wherein the fluid delivery element is configured to deliver a variety of fluids to the solar component.

In some aspects, the techniques described herein relate to a method further including providing a filter configured to remove contaminants from the fluid, Filtering the fluid before it is delivered to the solar component.

In some aspects, the techniques described herein relate to a method further including providing a blower; blowing the surface of the solar component with compressed air to clean the surface of the solar component; monitoring a second refraction of the index of the solar component to measure the performance of the blower. In some cases, the method includes blowing the surface of the solar component, and spraying the surface of the solar component.

In some aspects, the techniques described herein relate to a system for spraying condensate fluid including: a scrubber configured to move across a substantially smooth surface, the scrubber including: a water reservoir configured to substantially encapsulate a sprayer pump configured to deliver condensate from the water reservoir to a nozzle having a pre-orifice, first and second articulable arms configured to couple and extend from a housing of the scrubber, a condensation material configured to span between the first and second articulable arms and communicate with the water reservoir via a channel.

In some aspects, the techniques described herein relate to a system further including a sensor configured to detect debris on the smooth surface and communicate a signal to a controller to activate the scrubber.

In some aspects, the techniques described herein relate to a system wherein the scrubber is configured to adjust its angle in order to maximize contact with the surface.

Embodiments include one, more, or any combination of the various apparatus and methods described herein. Other features and advantages of the present disclosure will become apparent from the following more detailed description, taken in conjunction with the accompanying, which illustrate, by way of example, the principles of the disclosure.

### BRIEF DESCRIPTION OF THE DRAWINGS

FIG. 1 illustrates a front elevation perspective view of a solar component maintenance system, according to embodiments of the present disclosure.

FIG. 2A illustrates a front elevation view of a solar component maintenance system, according to embodiments of the present disclosure.

FIG. 2B illustrates a top perspective view of a solar component maintenance system, according to embodiments of the present disclosure.

FIG. 3 illustrates a side elevation view of a solar component maintenance system, according to embodiments of the present disclosure.

FIG. 4 illustrates a front elevation view of a solar component maintenance system, according to embodiments of the present disclosure.

FIG. 5 illustrates a condensate collection element, according to embodiments of the present disclosure.

FIG. 6 illustrates a condensate collection element, according to embodiments of the present disclosure.

FIG. 7 illustrates a condensate collection element, according to embodiments of the present disclosure.

FIG. 8 illustrates a front elevation view of a nozzle, according to embodiments of the present disclosure.

FIG. 9 illustrates a flowchart for a method of maintenance a solar component, according to embodiments of the present disclosure.

FIG. 10 illustrates a side perspective view of a system for spraying condensate, according to embodiments of the present disclosure.

Corresponding reference characters indicate corresponding parts throughout the several views.

While the disclosure is amendable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The following detailed description illustrates embodiments of the disclosure and manners by which they can be implemented. Although the best mode of carrying out the present disclosure has been disclosed, those skilled in the art would recognize that other embodiments for carrying out or practicing the present disclosure are also possible.

It should be noted that the terms “first,” “second,” and the like, herein do not denote any order, quantity, or importance, but rather are used to distinguish one element from another. Further, the terms “a” and “an” herein do not denote a limitation of quantity, but rather denote the presence of at least one of the referenced items. In some aspects, the techniques described herein relate to a system for maintenance and maintenance of solar components

A system for maintenance solar components, or a solar component cleaning system, can refer to a system that includes a solar component, such as a photovoltaic panel and/or array, a concentrated solar power array, and combinations thereof; and components and apparatus configured to clean or remove debris from the solar component. Similarly, the term maintenance can also encompass the regular cleaning of the solar components to maintain the operational parameters of the solar component, and efficiency of the photovoltaic effect of the solar component, according to some embodiments.

As used herein, the term “fluid” can refer to, but is not limited to atmospheric water condensation, water from a drainage line of a heat exchanger compressor unit, or any other water or fluid source or liquid and vapor beyond the critical points or solid/liquid/vapor triple points

In some embodiments, it is contemplated that the fluid can be combined with a chemical components to alter or control the freezing point or evaporation point of the fluid in the temperatures and pressures at which the solar component is operated. In some cases, the solar component can be operated at near vacuum pressures, 1.322×10\hat{ }−11 Pascals, and at temperatures between 0-737 Kelvin. The pressure in the solar component system can be modified to accommodate the fluid transfer within the system and delivered to the solar component in such extreme pressures and temperatures.

In some embodiments, it is contemplated that the chemical components can be recovered via the filtering process from the drainage of the solar component. In some cases, the chemical components can be a flocculant that adhere to particles removed from the solar component via the maintenance system, whereby the particles can be separated and sorted for chemical analysis, using the flocculant as a carrier particle to collect particles.

In some embodiments, the solar component system further includes an electrostatic charge system that includes a positive and negative charge able to impart an electrostatic charge on the surface of the solar component, thereby charging any particles on the surface of the solar component, wherein the chemical components in the fluid can be attracted to the charged particles and thereby binding the particles to the chemical components once the fluid is delivered to the solar component. In some cases, a second electrostatic charge can be applied to the collected fluid and particles, causing the chemical components to disassociate from the particles in solution, causing the particles to drop out of suspension, and be filtered and separated from the fluid.

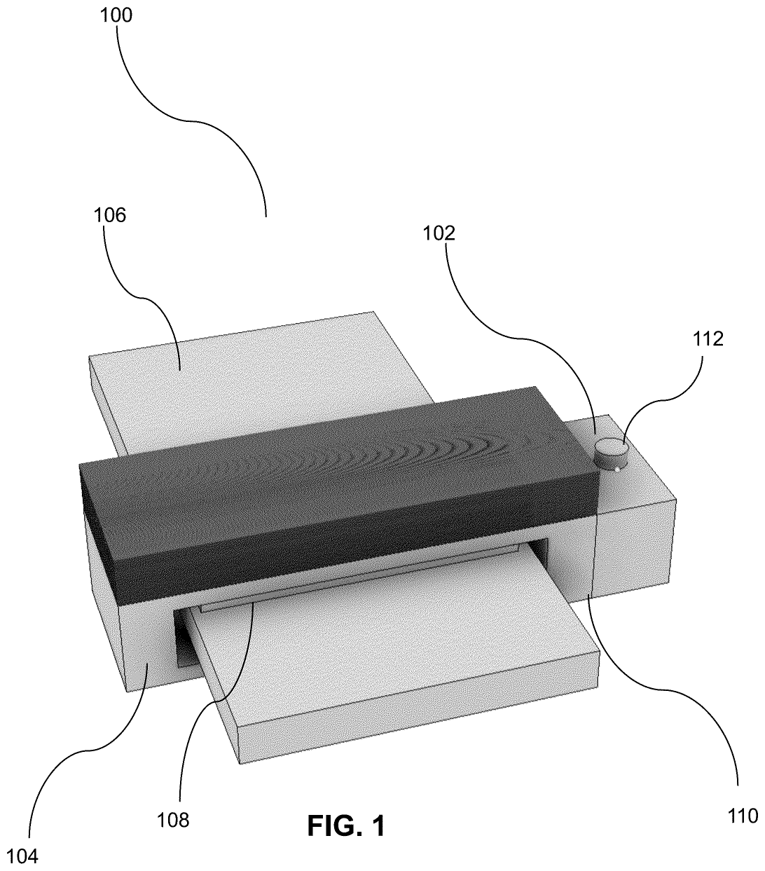

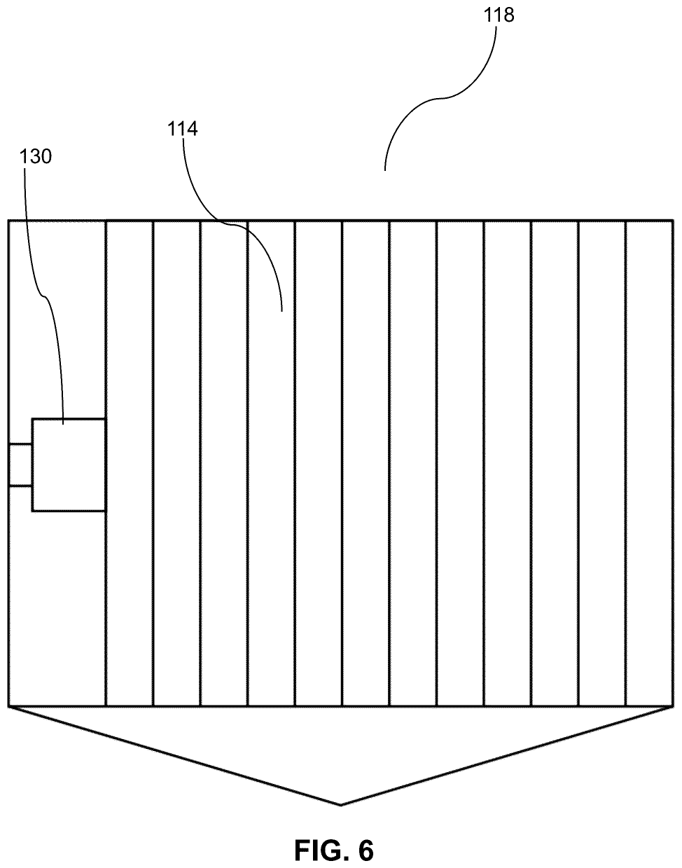

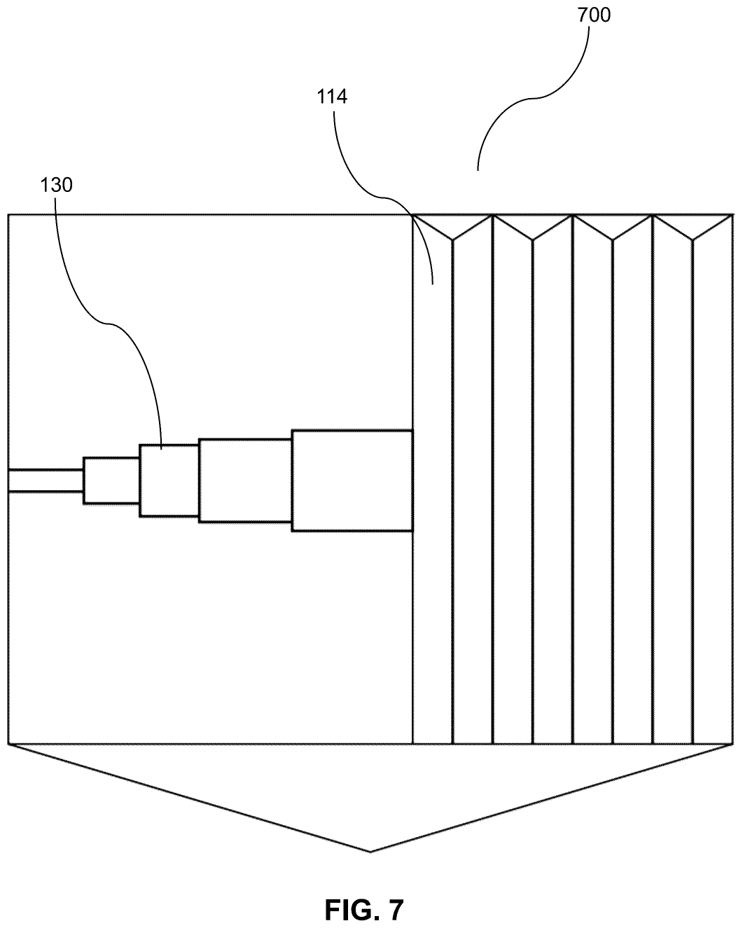

As shown in FIGS. 1-8 in some aspects, the techniques herein relate to a solar component system 100. In some cases, the solar component system 100 includes a condensate reservoir 102 that stores a fluid. The condensate reservoir 102 can be connected to a fluid delivery element 104. In some cases, the fluid delivery element 104 is a system of pipes, pressure vessels, and/or pumps configured to transport the fluid, via a pressure drop, from the condensate reservoir 102 to a solar component 106. According to embodiments of the present disclosure, the solar component system 100 can further include wiping element 108 operable by a motor 110 whereby the motor 110 is configured to operate the wiping element 108 via a controller 112.

In some aspects, the techniques described herein relate to a solar component system 100 further including a condensate collection element 114 configured to provide a plurality of nucleation elements 500 for water condensation. The condensate collection element 114 is configured to maximize sun exposure on one side to increase rate of atmospheric condensation formation on the surface of the condensate collection element 114, in some cases. The solar component system 100 is configured such that the condensate collection element 114 can be at least partially exposed to solar radiation.

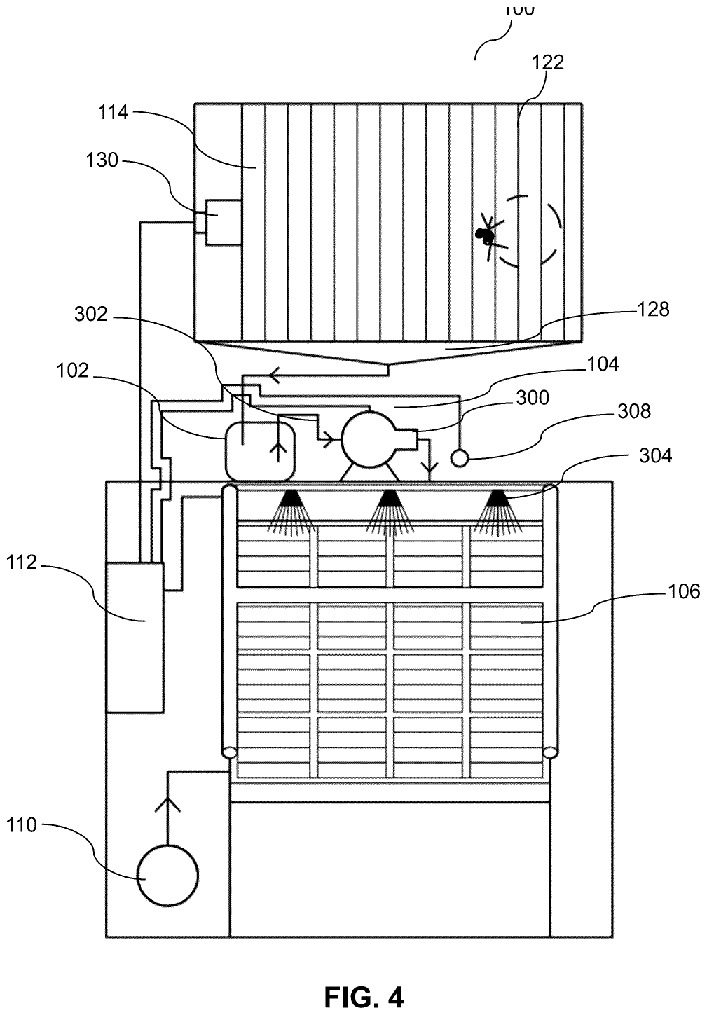

As shown in FIG. 4, 6-7 in some aspects, the techniques described herein relate to a solar component system 100 wherein the condensate collection element 114 is configured to change from a first position 118 to a second position 700, wherein the condensate collection element 114 in the first position 118 if configurable to form a condensate channel 122 configured to deliver water to the condensate reservoir 102. In some cases, the transition from the first position 118 to the second position 700 is a collapsible folding action, whereby the surface of the condensate collection element 114 collapsibly folds in on itself, similar to a hand-fan-like arrangement, and/or a pleated fashion.

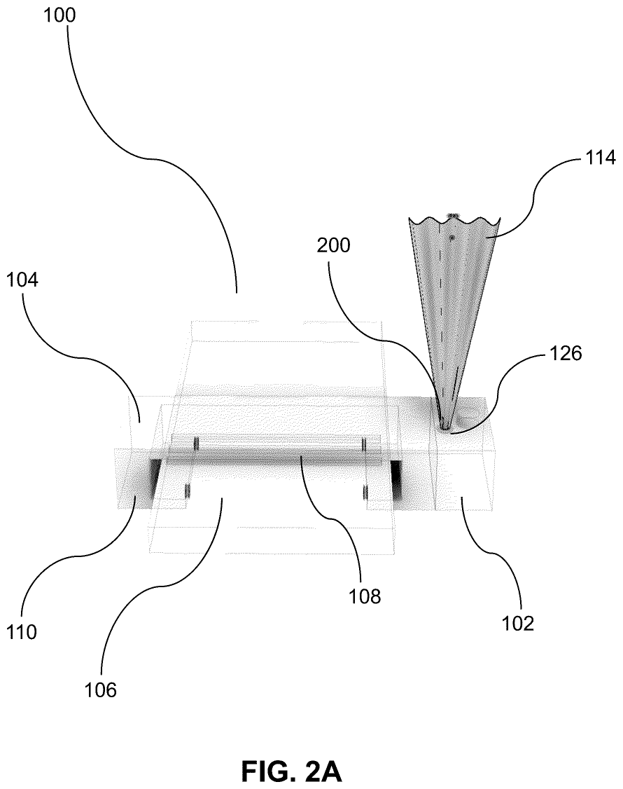

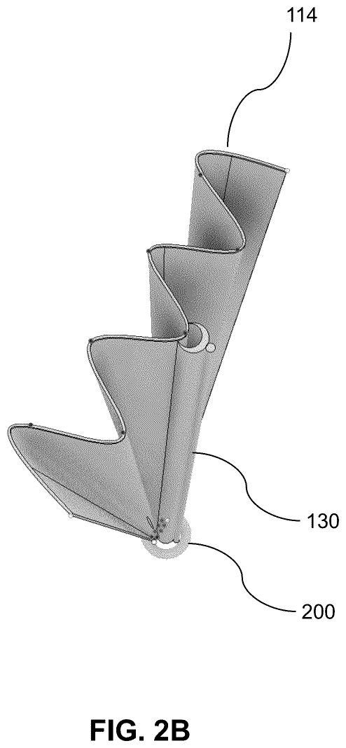

As shown in FIGS. 2A and 2B in some embodiments, the change from the first position 118 to a second position 700 can be accomplished through the use of a compressive ring 200 In some cases, in the first position 118 the compressive ring 200 is maintained at the condensate collection element base 126, and in the second position 700 the compressive ring 200 is actuated along the condensate collection element 114, causing the condensate collection element 114 to fold in along itself in a fan-like action, squeezing the condensate collection element 114, thereby causing the condensate to gravitationally and non-gravitationally flow through and across the condensate collection element 114, into a collection element 128 and into the condensate reservoir 102. In some cases, the compressive ring 200 moves along an actuating element 130.

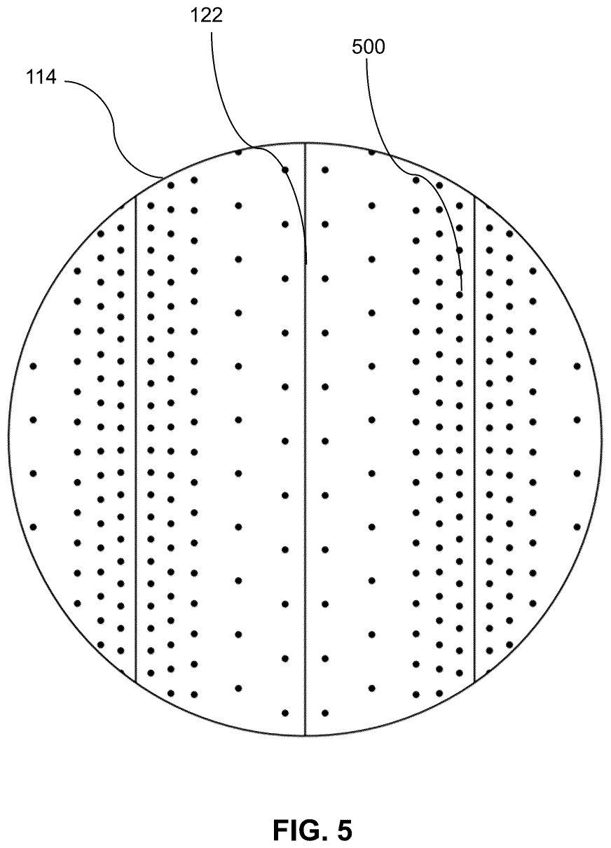

In some aspects, as shown in FIG. 5, the techniques described herein relate to a solar component system 100 wherein the condensate collection element 114 has a condensate channel 122 comprising a hydrophobic element and a plurality of nucleation elements 500. In some cases, the hydrophobic element can be hydrophobic coating can have a contact angle of at least 90 degrees. It is contemplated that in some embodiments the hydrophobic element is a superhydrophobic hierarchical micro/nanostructure such as, but not limited to: sealed layered nanoporous structures, open nanocone structures, organosilane compounds, copper-based compounds, polymeric compounds, or combination thereof. In some cases, the plurality of nucleation elements 500 are configured to promote nucleation of condensate on the condensate collection element 114. The plurality of nucleation elements 500, in some cases, can extend beyond the condensate channel 122 and be surrounded by the hydrophobic element. In some cases, the plurality of nucleation elements 500 and the hydrophobic element are arranged such that the condensate droplets formed on the plurality of nucleation elements 500 are gravitationally pulled onto the hydrophobic element, whereby the hydrophobic element and condensate channel 122 are configured to direct condensate to a collection element.

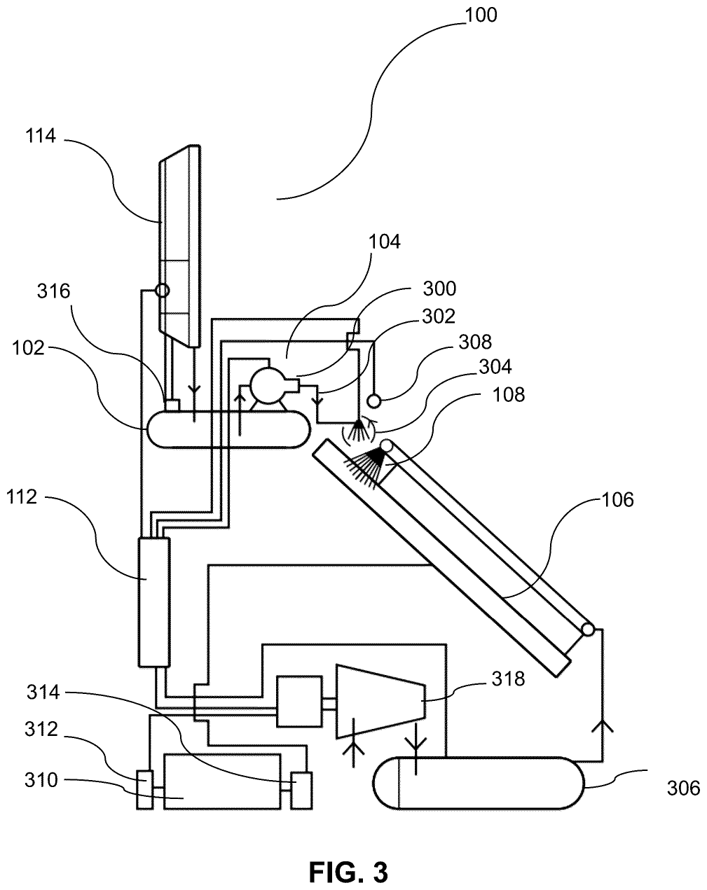

In some aspects, as shown in FIGS. 3-4 the techniques described herein relate to a solar component system 100 wherein the fluid delivery element 104 includes a pump 300, configured to couple to with a manifold 302; wherein the manifold 302 and the pump 300 are operable to deliver the fluid or condensate to a nozzle 304 configured to deliver the fluid to the solar component 106 via a maintenance signal from the controller 112. The pump 300 can be, but is not limited to: a positive-displacement pump, and velocity pump, and/or an impulse pump. In such cases where the pump 300 is a velocity or impulse pump, the solar component system 100 can include a pressure vessel 306 exposed to incident solar radiation. In some cases, the pressure vessel 306 is configured to deliver pneumatic pressure to operate the wiping element 108.

In some aspects, the techniques described herein relate to a system wherein the fluid delivery element 104 further includes a sensor 308 configured to monitor a refraction index of the surface of the solar component 106 and communicate a positive signal to the controller 112 in reference to a set point of the surface refraction index of the solar component 106. In some cases, the sensor 308 configured to monitor refraction index comprises as laser beam, a laser screen, a camera, and a central processor, wherein the camera captures the scattering of the laser beam upon the surface of the solar component 106 and the central processor makes a comparison of the angle of incidence of the laser beam to that of the scattered laser beam resulting in a refraction index. In some cases, the central processor further includes a refraction index standard, or set point. In such cases where the sensor measures a refraction index above the set point, the central processor will send a maintenance alert to the controller 112.

In some aspects, the techniques described herein relate to a solar component system 100 wherein the controller 112 is configured to transmit a maintenance signal to the motor 110 and transmit a pumping signal to the pump 300. In some cases, the controller 112 will deliver a maintenance signal to the motor 110, and a pumping signal to the pump 300, upon receipt of the maintenance alert from the central processor. In some cases, the maintenance signal is transmitted from the controller 112 to the motor 110 via a local network, wherein the controller 112 has a transmitter and the motor 110 has a receiver. In some cases, the pump 300 and controller 112 are configured to communicate via Bluetooth or other radio frequencies. In some cases, the pumping signal is transmitted from the controller 112 to the pump 300 via a local network, wherein the controller has a transmitter, and the pump has a receiver.

In some aspects, the techniques described herein relate to a solar component system 100 wherein the manifold 302 also includes a reservoir pressure sensor configured to measure the internal pressure of the condensate reservoir 102. In some cases, the solar component system 100 also includes a nozzle pressure sensor that is configured to measure the pressure of the nozzle 304. In some cases, the condensate reservoir pressure sensor and nozzle pressure sensor are configured to each transmit signals to the controller 112. In such cases, the signals from the reservoir pressure sensor and the nozzle pressure sensor may be transmitted wirelessly through a local network and/or radio frequency, such as Bluetooth. The controller 112 may further include a time delay component. The time delay component is calculated from the pressure signals of the condensate reservoir 102 and nozzle pressure sensor such that a pressure drop between the reservoir pressure sensor and the nozzle pressure sensor can be communicated, via wireless network, radio signal, or otherwise, to the central processing unit, wherein the central processing network can compute a time delay component, wherein the time delay component is transmitted to the controller 112, such that the transmission of the maintenance signal from the controller 112 to the motor 110 is delayed to a time after the pumping signals is transmitted, thereby communicating the nozzle 304 to spray fluid from the condensate reservoir 102 and manifold 302 before the motor 110 operates the wiping element 108.

In some cases, the techniques described herein relate to a solar component system 100 that also includes a clock mechanism that is configured to communicate with the controller 112, whereby the controller 112 may function based upon a reading of the clock in reference to a user-input operational set-point, such as a time delay or timer setting.

In some aspects, the techniques described herein relate to a solar component system 100 further including a heat exchanger configured to communicate a condensate fluid to the condensate reservoir 102 via a drainage line that extends from the heat exchanger to the condensate reservoir 102.

As shown in FIG. 3 In some aspects, the techniques described herein relate to a solar component system 100 further including: a battery 310, a charge controller 312, and an inverter 314; wherein the solar component 106 including a photovoltaic cell is configured to transmit a photovoltaic (PV) current to the charge controller 312, the charge controller 312 being configured to communicate a charge current to the battery 310, and the battery 310 being configured to deliver a voltage to the inverter 314, and the inverter 314 configured to deliver a circuit voltage to the motor 110, central processing unit, pump 300, and the controller 112.

As shown in FIG. 3 in some aspects, the techniques described herein relate to a solar component system 100 further including a filter 316 configured to remove contaminants from the fluid before it is delivered to the solar component 106. In some cases, the filter 316 may be located in the manifold 302 and be between the condensate collection element 114 and the condensate reservoir 102. In some cases, the filter 316 includes a vibration chamber configured to communicate with an ultrasonic vibration element. In some cases, the ultrasonic vibration element can vibrate ultrasonically to break up solidified contaminants present in the filter 316. In some cases, the filter may also include a vacuum element, configured to remove by suction the contaminants that have been ultrasonically vibrated.

As shown in FIG. 3 In some aspects, the techniques described herein relate to a solar component system 100 further wherein the reservoir is configured to be a pressure vessel 306; wherein the wiping element 108 is configured to be pneumatically operably by a pressure of the pressure vessel 306, and a compressor 318. In some cases, the central processing unit can calculate the pressure of the pressure vessel 306, via a pressure reservoir pressure sensor, and can deliver a pulse-width modulation (PWM) of the pumping signal based on the pressure of the pressure-vessel reservoir.

In some aspects, the techniques described herein relate to a solar component system 100 wherein the controller 112 is configured to modify the PWM of the pumping signal based on the refraction index of the solar component 106. In such cases, the amount of condensate delivered through the nozzle 304 is increased by the controller via the PWM of the pumping signal to the pump 300.

In some aspects, the techniques described herein relate to a solar component system 100 further including a timer configured to automatically activate the solar component system 100 at predetermined intervals. The predetermined intervals can be set by user through the use of a user interface configured to communicate through a local network or radio frequency with the controller 112. The user interface may be a software interface configured to operate on a mobile device, computer, or tablet. In some cases, the user interface may be adapted to communicate with a network enabled web browser.

In some aspects, the techniques described herein relate to a solar component system 100 wherein the wiping element 108 is configured to adjust its angle in order to maximize contact with the solar component. In some cases, the wiping element 108 has an adjustable blade that can be manipulated to adjust the angle that the adjustable blade makes contact with the solar component 106.

In some aspects, the techniques described herein relate to a solar component system 100 wherein the fluid delivery element 104 is configured to deliver a variety of fluids to the solar component 106. In some cases, the solar component system 100 may include more than one reservoir, wherein at least one of the reservoirs comprises a low-freezing temperature fluid that comprises a solute and solvent, where the solute decreases the freezing temperature of the solution to below negative 20 (−20) degrees Celsius.

In some aspects, the techniques described herein relate to a solar component system 100 further including a heating element configured to heat the fluid before it is delivered to the solar component 106.

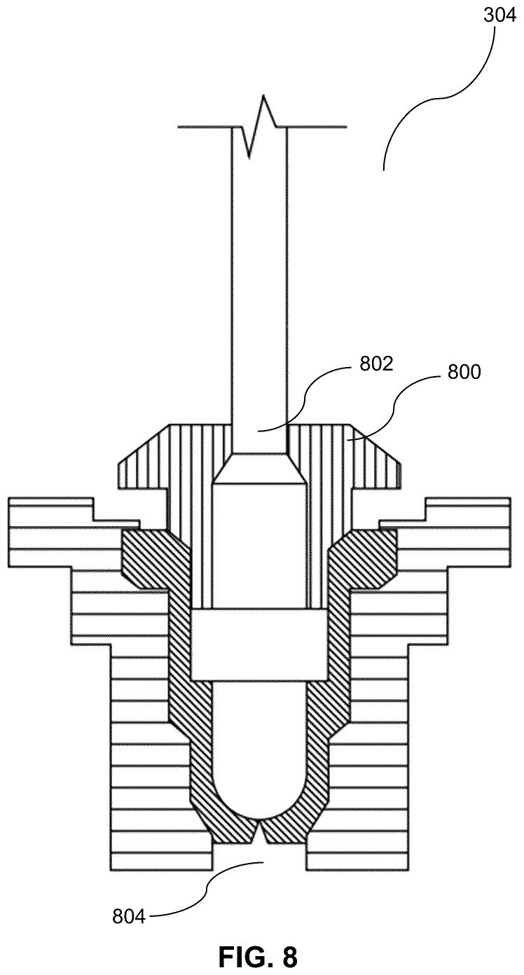

As shown in FIG. 8 in some aspects, the techniques herein relate to a solar component system 100 wherein the nozzle 304 can be configured to have a metering plate 800 near the inlet 802 of the nozzle 304 configured to control flow rate in the nozzle 304. In some cases, the nozzle 304 also includes an exit orifice 804 configured to create a flat fan spray pattern. The nozzle 304 can have an exit orifice 804 that is larger than the metering plate 800 and is thus configured to create a pressure drop within the nozzle 304, which is advantageous in producing thicker, flat fan spray patterns, larger spray droplets, and reducing blockages, thereby increasing the wetting efficiency on the solar component 106 by the nozzle 304 design.

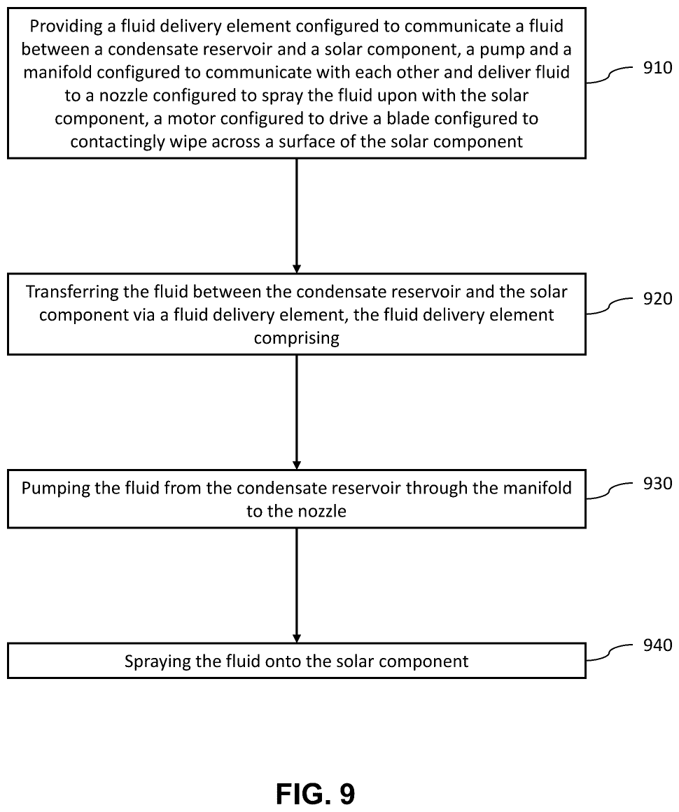

As shown in FIG. 9 In some aspects, the techniques described herein relate to a method of removing debris from a solar panel, including: Providing a fluid delivery element configured to communicate a fluid between a condensate reservoir and a solar component; a pump and a manifold configured to communicate with each other and deliver fluid to a nozzle configured to spray the fluid upon with the solar component, a motor configured to drive a blade configured to contactingly, or make contact sufficient to remove debris, and wipe across a surface of the solar component 910; and Transferring the fluid between the condensate reservoir and the solar component via a fluid delivery element, the fluid delivery element including 920: pumping the fluid from the condensate reservoir through the manifold to the nozzle 930; and spraying the fluid onto the solar component 940.

In some aspects, the techniques described herein relate to a system wherein the fluid delivery element is configured to deliver a variety of fluids to the solar component.

In some aspects, the techniques described herein relate to a method, further including: Providing a condensate collection element including a plurality nucleation sites and a condensate channel, the condensate channel configured deliver the fluid into the condensate channel.

In some aspects, the techniques described herein relate to a method wherein the condensate collection element further includes a first position, a second position, the first position configured to maximize a surface are of the condensate collection element, the second position configured to form the condensate channel; positioning the condensate collection element in the first position to collect condensation of water vapor; collecting a fluid condensate at the nucleation site; adjusting the condensate collection element to the second position; forming the condensate channel; and channeling the fluid condensate to the condensate reservoir.

In some aspects, the techniques described herein relate to a method further including: providing an actuator configured to couple with the condensate collection element, and actuate the condensate collection element between the first and the second position; actuating the collection element from the first position to the second position; and actuating the collection element from the second position to the first position.

In some aspects, the techniques described herein relate to a method wherein the fluid delivery element further includes: A sensor configured to monitor and record a refraction index of a solar component and a signal to a controller configured to compare the refraction index to a reference number, and to communicate with the fluid delivery element; Monitoring the refraction index of the solar component; Recording the refraction index; Transmitting the signal to the controller; Comparing the refraction index to a reference number; and Controlling the pump and motor on a time delay enabling fluid releasing from the nozzle, and wiping of the blade across the solar component surface.

In some aspects, the techniques described herein relate to a method further including: providing an actuator configured to communicate with the controller and the condensate collection element; and controlling the actuator to adjust the position of the condensate collection element.

In some aspects, the techniques described herein relate to a method further including heating the fluid before it is delivered to the solar component.

In some aspects, the techniques described herein relate to a method further including: Monitoring a temperature of the solar component, and adjusting the heating of the fluid.

In some aspects, the techniques described herein relate to a method wherein the fluid delivery element is configured to deliver a variety of fluids to the solar component.

In some aspects, the techniques described herein relate to a method further including providing a filter configured to remove contaminants from the fluid, Filtering the fluid before it is delivered to the solar component.

In some aspects, the techniques described herein relate to a method further including providing a blower; blowing the surface of the solar component with compressed air to clean the surface of the solar component; monitoring a second refraction of the index of the solar component to measure the performance of the blower. In some cases, the method includes blowing the surface of the solar component, and spraying the surface of the solar component.

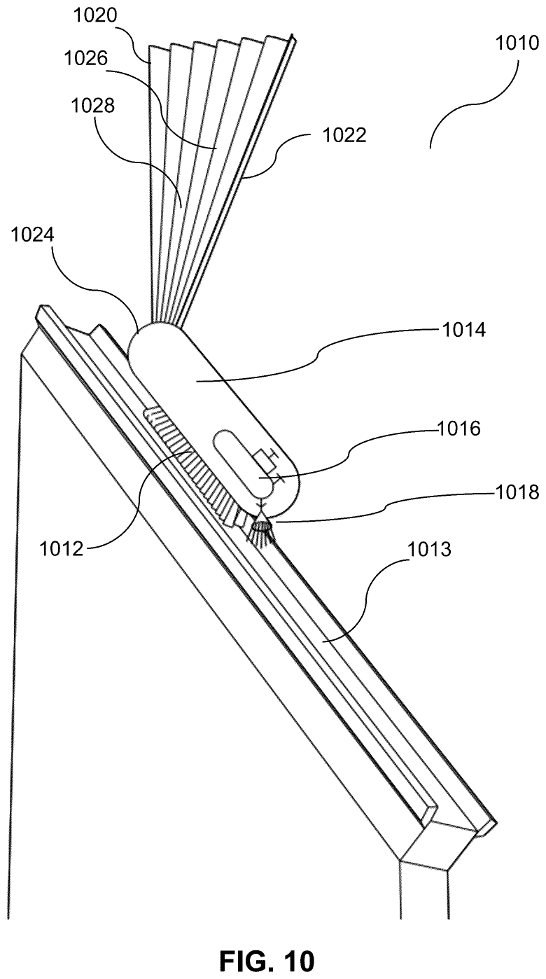

As show in FIG. 10, in some aspects, the techniques described herein relate to a condensate fluid spraying system 1010 including: a scrubber 1012 configured to move across a smooth surface 1013, the scrubber 1012 may include a water reservoir 1014 configured to house, or substantially encapsulate a submersible sprayer pump 1016 configured to deliver condensate from the water reservoir 1014 to a nozzle 1018 having a metering plate with a pre-orifice smaller in diameter than the exit orifice, first articulable arm 1020 and a second articulable arm 1022 configured to couple and extend from a housing 1024 of the scrubber 1012, a condensation material 1026 configured to span between, first articulable arm 1020 and the second articulable arm 1022 and communicate with the water reservoir 1014 via a channel 1028.

In some aspects, the techniques described herein relate to a condensate fluid spraying system 1010 further including a sensor configured to detect debris on the smooth surface 1013 and communicate a signal to a controller to activate the scrubber 1012.

In some aspects, the techniques described herein relate to a condensate fluid spraying system 1010 wherein the scrubber 1012 is configured to adjust its angle in order to maximize contact with the smooth surface 1013.

Embodiments include one, more, or any combination of the various apparatus and methods described herein. Other features and advantages of the present disclosure will become apparent from the following more detailed description, taken in conjunction with the accompanying, which illustrate, by way of example, the principles of the disclosure.

The examples mentioned above are merely used for illustrative purposes and not meant to be limitations of the present disclosure.

What is claimed is:

1. A system for maintenance solar components, comprising:
a condensate reservoir,
a wiping element,
a motor, and
a fluid delivery element;
wherein the fluid delivery element is configured to transport a fluid from the condensate reservoir to a solar component, and the motor is configured to operate the wiping element via a controller.

2. The system of claim 1 further comprising a condensate collection element further comprising a plurality of nucleation sites for water condensation.

3. The system of claim 2 wherein the condensate collection element is configured to collapsibly fold from a first position to a second position, wherein the condensate collection element in the first position if configurable to form a condensate channel configured to deliver water to the condensate reservoir.

4. The system of claim 3 wherein the condensate channel comprises a hydrophobic coating.

5. The system of claim 1 wherein the fluid delivery element comprises a pump, configured to couple to with a manifold; wherein the manifold and the pump are operable to deliver the fluid to a nozzle configured to deliver the fluid to the solar component via a maintenance signal from the controller.

6. The system of claim 5 wherein the fluid delivery element further comprises a sensor configured to monitor a refraction index of a surface and communicate a positive signal to the controller in reference to a set point of the refraction index of the solar component.

7. The system of claim 6 wherein the controller is configured to transmit a maintenance signal to the motor and transmit a pumping signal to the pump.

8. The system of claim 7 wherein the manifold further comprises a reservoir pressure sensor and a nozzle pressure sensor.

9. The system of claim 8 wherein the reservoir pressure sensor and the nozzle pressure sensor are configured to each transmit a pressure signal to the controller;
wherein the controller further comprises a time delay component calculated from the pressure signal of the reservoir pressure sensor and the pressure signal of the nozzle pressure sensor;
wherein the maintenance signal and pumping signal are in reference to the time delay component.

10. The system of claim 1 further comprising a heat exchanger configured to communicate a condensate fluid to the condensate reservoir.

11. The system of claim 3 further comprising:
a battery,
a charge controller, and
an inverter;
wherein the solar component comprising a photovoltaic cell is configured to transmit a PV current to the charge controller configured to communicate a charge current to the battery configured to deliver a voltage to the inverter configured to deliver a circuit voltage to the motor and the controller.

12. The system of claim 11 further comprising an actuator configured to manipulate the condensate collection element between the first position and the second position.

13. The system of claim 12 wherein the controller further comprises a clock configured to a deliver a folding signal to the actuator based upon a time reference setting.

14. A method of removing debris from a solar panel, comprising:
Providing a fluid delivery element configured to communicate a fluid between a condensate reservoir and a solar component;
a pump and a manifold configured to communicate with each other and deliver fluid to a nozzle configured to spray the fluid upon with the solar component, a motor configured to drive a blade configured to contactingly wipe across a surface of the solar component;
Transferring the fluid between the condensate reservoir and the solar component via a fluid delivery element, the fluid delivery element comprising:
pumping the fluid from the condensate reservoir through the manifold to the nozzle; and
spraying the fluid onto the solar component.

15. The method of claim 14, further comprising:
Providing a condensate collection element comprising a nucleation site and a condensate channel, the condensate channel configured deliver the fluid into the condensate channel.

16. The method of claim 15 wherein the condensate collection element further comprises a first position, a second position, the first position configured to maximize a surface are of the condensate collection element, the second position configured to form the condensate channel;
positioning the condensate collection element in the first position to collect condensation of water vapor;
collecting a fluid condensate at the nucleation site;
adjusting the condensate collection element to the second position;
forming the condensate channel; and
channeling the fluid condensate to the condensate reservoir.

17. The method of claim 16 further comprising:
providing an actuator configured to couple with the condensate collection element, and actuate the condensate collection element between the first position and the second position;
actuating the condensate collection element from the first position to the second position; and
actuating the condensate collection element from the second position to the first position.

18. The method of claim 15 wherein the fluid delivery element further comprises:
A sensor configured to monitor and record a refraction index of a solar component and a signal to a controller configured to compare the refraction index to a reference number, and to communicate with the fluid delivery element;
Monitoring the refraction index of the solar component;
Recording the refraction index;
Transmitting the signal to the controller;
Comparing the refraction index to a reference number; and
Controlling the pump and motor on a time delay enabling fluid releasing from the nozzle, and wiping of the blade across the solar component.

19. The method of claim 15 further comprising:
providing an actuator configured to communicate with the condensate collection element and a controller configured to communicate with the actuator; and
controlling the actuator to adjust a position of the condensate collection element.

20. A system for spraying condensate fluid comprising:
a scrubber configured to move across a substantially smooth surface, the scrubber comprising:
a fluid reservoir configured to substantially encapsulate a sprayer pump configured to deliver condensate from the fluid reservoir to a nozzle having a metering plate, first and second articulable arms configured to couple and extend from a housing of the scrubber, a condensation material configured to span between the first and second articulable arms and communicate with the fluid reservoir via a channel.
